(19) United States
(12) Patent Application Publication
(10) Pub. No.: US 2025/0365204 A1
(43) Pub. Date: Nov. 27, 2025

(54) Detecting Degradation of an Internet Network Chain in a Radio Access Network

(71) Applicants: DISH Wireless L.L.C., Englewood, CO (US); DISH Network Technologies India Private Limited, Bangalore (IN)

(72) Inventors: Dawood SHAHDAD, Aurora, CO (US); Jaya Chandra CHIKATMARLA, Highlands Ranch, CO (US); Manvendra SINGH, Highlands Ranch, CO (US); Brijesh MISHRA, Bangalore (IN)

(73) Assignees: DISH Network Technologies India Private Limited, Bangalore, KA (IN); DISH Wireless L.L.C., Englewood, CO (US)

(21) Appl. No.: 18/671,859

(22) Filed: May 22, 2024

(51) Int. Cl. H04L 41/122; H04L 41/0659; H04L 43/0817; H04L 43/10

(52) U.S. Cl. CPC H04L 41/122; H04L 41/0659; H04L 43/0817; H04L 43/10

(57) ABSTRACT

The present teachings involves managing network connectivity in a radio access network, such as a Fifth Generation (5G) network. This includes performing a network health check for each N6 chain towards an Internet site by a user plane function (UPF), disabling a pod managing a degraded N6 chain by the UPF in response to the health check indicating a failure, and notifying a Session Management Function (SMF) to stop allocating the disabled pod for Internet Traffic. The system includes a UPF configured to perform the health check, disable the pod, and send a notification, and an SMF configured to stop allocating the disabled pod in response to the notification.

### FIELD

The present teachings relate to the field of 5G Network, specifically to the Session Management Function (SMF) and User Plane Function (UPF) in a 5G Service-Based Architecture (SBA). It involves the establishment of an N6 chain (data path) between User Equipment (UE) of the 5G Network and the Internet, and detecting degradation along the N6 chain.

### BACKGROUND

Session Management Function (SMF) is a fundamental element of the 5G Service-Based Architecture (SBA). The SMF keeps trace of Packet Data Unit (PDU) sessions and Quality of Service (QoS) flows in a Fifth Generation Core (5GC) for User Equipment (UE) and ensures their states and status are in sync between Network Functions in Control and User Planes. PDU Session Establishment establishes a data path between the UE and the 5GC network. As such, a PDU session is a logical connection between the UE and a data network, such as the internet or a private network.

The user plane function (UPF) is the data plane in the 5GC. After an Access Gateway Function (AGF) authenticates a subscriber and establishes a protocol data unit (PDU) session, the session management function (SMF) selects a UPF for the subscriber.

There is a need to automatically detect and correct a service downtime for data network disruption on a N6 chain in a 5G RAN. In today's architecture, an SMF may be deployed in each Regional Data Center (RDC). The multiple SMFs communicate with multiple UPFs (typically 4-5) for data service. Each of these multiple UPFs has multiple pods that handle multiple N6 service chains. In the prior art, the SMF stops using a specific pod during pod selection after a failure to establish an N6 chain. After selection and establishment of the N6 chain, the SMF does not detect or correct run-time failures in an N6 chain, for example, when the N6 chain cannot reach Internet hosts on the Internet, when an Internet Service Provider for the pod fails, a firewall along the N6 chain denies service or the like. Moreover, a pod that serves the N6 chain on the UPF may be functioning but there is a downstream problem that breaks the N6 chain's connectivity to the internet. This error is not detected or corrected in the prior art.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Session Management Function (SMF) is a fundamental element of the 5G Service-Based Architecture (SBA). The user plane function (UPF) is the data plane in a Fifth Generation Core (5GC) for User Equipment (UE). In today's architecture, an SMF may be deployed in each Regional Data Center (RDC). The multiple SMFs communicate with multiple UPFs (typically 4-5) for data service. Each of these multiple UPFs has multiple pods that handle multiple N6 service chains. In the prior art, the SMF stops using a specific pod during pod selection for establishing an N6 chain. After selection and establishment of an N6 chain, the present teachings detect or correct failures in a N6 chain in the pod, a downstream problem that breaks the N6 chain's connectivity to the internet or the like.

In some aspects, the techniques described herein relate to a method for managing network connectivity in a Radio Access Network (RAN), the method including: performing a network health check, for each N6 chain of N6 chains, towards an Internet site by a user plane function (UPF); disabling a pod managing a degraded N6 chain by the UPF in response to the network health check indicating a failure; notifying a Session Management Function (SMF) to stop allocating the disabled pod for Internet Traffic; and setting a status of unavailable for the disabled pod until a correction or restoration is completed.

In some aspects, the techniques described herein relate to a method, wherein the Internet site includes multiple domain name servers.

In some aspects, the techniques described herein relate to a method, wherein the UPF has multiple pods that handle multiple N6 service chains.

In some aspects, the techniques described herein relate to a method, wherein the SMF is deployed in a Regional Data Center (RDC) and communicates with multiple UPFs for data service.

In some aspects, the techniques described herein relate to a method, wherein the SMF selects a UPF for a UE after an Access Gateway Function (AGF) authenticates the UE and establishes a protocol data unit (PDU) session.

In some aspects, the techniques described herein relate to a method, further including keeping trace of Packet Data Unit (PDU) sessions and Quality of Service (QoS) flows in a Fifth Generation Core (5GC) for User Equipment (UE).

In some aspects, the techniques described herein relate to a method, further including ensuring states and status of the PDU sessions and QoS flows are in sync between Network Functions in Control and User Planes.

In some aspects, the techniques described herein relate to a method, further including setting a status of unavailable for the disabled pod until a correction or restoration is completed.

In some aspects, the techniques described herein relate to a method, wherein the disabled pod is associated with an IP Pool for Internet Traffic and the SMF replaces N6 chains associated with the disabled pod by allocating new N6 chains on a different pod.

In some aspects, the techniques described herein relate to a method, wherein the network health check includes pinging an Internet host periodically.

In some aspects, the techniques described herein relate to a method, wherein the notifying includes alerting a Network Operations Center (NOC).

In some aspects, the techniques described herein relate to a system to manage network connectivity in a Radio Access Network (RAN), the system including: a user plane function (UPF) configured to perform a network health check, for each N6 chain of N6 chains, towards an Internet site, to disable a pod associated with a degraded N6 chain in response to the network health check indicating a failure, and to send a notification regarding the disabled pod; and a Session Management Function (SMF) configured to stop allocating the disabled pod for Internet Traffic in response to the notification from the UPF.

In some aspects, the techniques described herein relate to a system, wherein the Internet site including multiple domain name servers.

In some aspects, the techniques described herein relate to a system, wherein the UPF has multiple pods that handle multiple N6 service chains.

In some aspects, the techniques described herein relate to a system, wherein the SMF is deployed in a Regional Data Center (RDC) and communicates with multiple UPFs for data service.

In some aspects, the techniques described herein relate to a system, wherein the SMF selects a UPF for a User Equipment (UE) after an Access Gateway Function (AGF) authenticates the UE and establishes a protocol data unit (PDU) session.

In some aspects, the techniques described herein relate to a system, wherein the SMF keeps trace of Packet Data Unit (PDU) sessions and Quality of Service (QoS) flows in a Fifth Generation Core (5GC) for User Equipment (UE).

In some aspects, the techniques described herein relate to a system, wherein the SMF ensures states and status of the PDU sessions and QoS flows are in sync between Network Functions in Control and User Planes.

In some aspects, the techniques described herein relate to a system, further including the SMF sets a status of unavailable for the disabled pod until a correction or restoration is completed.

In some aspects, the techniques described herein relate to a system, wherein the pod is associated with an IP Pool for Internet Traffic and the SMF replaces N6 chains associated with the disabled pod by allocating new N6 chains on a different pod.

Additional features will be set forth in the description that follows, and in part will be apparent from the description, or may be learned by practice of what is described.

### DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1 illustrates an embodiment of a hybrid cloud cellular network.

FIG. 2 illustrates an embodiment of a 5G Core.

FIG. 3 illustrates an embodiment of a hybrid cloud cellular network architecture.

FIG. 4 illustrates a system to manage network connectivity in a Fifth Generation (5G) network, according to various embodiments.

FIG. 5 is a flowchart of a method for managing network connectivity in a Fifth Generation (5G) network, according to various embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present teachings may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. Introduction

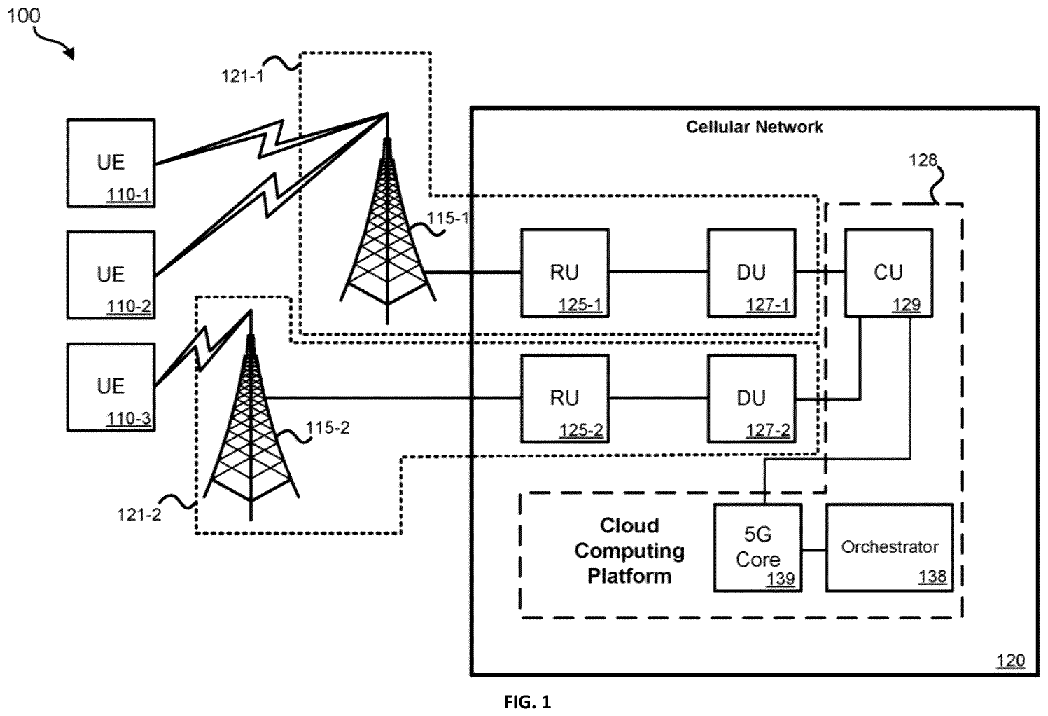

FIG. 1 illustrates a block diagram of a hybrid cellular network system (“system 100”). System 100 can include a 5G New Radio (NR) cellular network; other types of cellular networks, such as 6G, 7G, etc., may also be possible. System 100 can include: UE 110 (UE 110-1, UE 110-2, UE 110-3); structure 115; cellular network 120; radio units 125 (“RUs 125”); distributed units 127 (“DUs 127”); centralized unit 129 (“CU 129”); 5G core 139; and orchestrator 138. FIG. 1 represents a component-level view. In an open radio access network (O-RAN), most components, except for components that need to receive and transmit RF, can be implemented as specialized software executed on general-purpose hardware or servers. For at least some components, the hardware may be maintained by a separate cloud-service computing platform provider. Therefore, the cellular network operator may operate some hardware (such as, RUs and local computing resources on which DUs are executed) connected with a cloud-computing platform on which other cellular network functions, such as the core and CUs are executed.

UE 110 can represent various types of end-user devices, such as cellular phones, smartphones, cellular modems, cellular-enabled computerized devices, sensor devices, robotic equipment, IoT devices, gaming devices, access points (APs), or any computerized device capable of communicating via a cellular network. More generally, UE 110 can represent any type of device that has an incorporated 5G interface, such as a 5G modem. Examples can include sensor devices, Internet of Things (IoT) devices, manufacturing robots, unmanned aerial (or land-based) vehicles, network-connected vehicles, or the like. Depending on the location of individual UEs, UE 110 may use RF to communicate with various BSs of cellular network 120. BS 121 may include an RU (e.g., RU 125-1) and a DU (e.g., DU 127-1). Two BSs 121 (BS 121-1 and BS 121-2) are illustrated. BS 121-1 can include: structure 115-1, RU 125-1, and DU 127-1. Structure 115-1 may be any structure to which one or more antennas (not illustrated) of the BS are mounted. Structure 115-1 may be a dedicated cellular tower, a building, a water tower, or any other man-made or natural structure to which one or more antennas can reasonably be mounted to provide cellular coverage to a geographic area. Similarly, BS 121-2 can include: structure 115-2, RU 125-2, and DU 127-2.

Real-world implementations of system 100 can include many (e.g., thousands) of BSs and many CUs and 5G core 139. BS 121-1 can include one or more antennas that allow RUs 125 to communicate wirelessly with UEs 110. RUs 125 can represent an edge of cellular network 120 where data is transitioned to RF for wireless communication. The radio access technology (RAT) used by RU 125 may be 5G NR, or some other RAT. The remainder of cellular network 120 may be based on an exclusive 5G architecture, a hybrid 4G/5G architecture, or some other cellular network architecture that supports cellular network slices.

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. In some embodiments, an RU can also operate on three bands. One or more DUs, such as DU 127-1, may communicate with CU 129. Collectively, an RU, DU, and CU create a gNodeB, which serves as the radio access network (RAN) of cellular network 120. DUs 127 and CU 129 can communicate with 5G core 139. The specific architecture of cellular network 120 can vary by embodiment. Edge cloud server systems (not illustrated) outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O- RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized implementation, CU 129, 5G core 139, and/or orchestrator 138 can be implemented virtually as software being executed by general-purpose computing equipment on a cloud-computing platform 128, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where 5G core 139 is executed, while other functions are executed at a separate server system or on a separate cloud computing system. In the illustrated embodiment of system 100, cloud-computing platform 128 can execute CU 129, 5G core 139, and orchestrator 138. The cloud-computing platform 128 can be a third-party cloud-based computing platform or a cloud-based computing platform operated by the same entity that operates the RAN. Cloud-based computing platform 128 may have the ability to devote additional hardware resources to cloud-based cellular network components or implement additional instances of such components when requested.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new DU for test, orchestrator 138 can perform a pipeline of calling the DU code from a software repository incorporated as part of, or separate from cellular network 120, pulling corresponding configuration files (e.g. helm charts), creating Kubernetes nodes/pods, loading DU containers, configuring the DU, and activating other support functions (e.g. Prometheus, instances/connections to test tools). While this instantiation of a DU may be triggered by orchestrator 138, a chaos test system may introduce false DU container images in the repo, may introduce latency or memory issues in Kubernetes, may vary traffic messaging, and/or create other “chaos” in order to conduct the test. That is, chaos test system is not only connected to a DU, but is connected to all the layers and systems above and below a DU, as an example.

Kubernetes, Docker®, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The traditional OSS/BSS stack exists above orchestrator 138. Chaos testing of these components, as well as other higher layer custom-built components. Such components can be required sources of information and agents for testing at the service/app/solution layer. One aim of chaos testing is to verify the business intent (service level objectives (SLOs) and SLAs) of the solution. Therefore, if we commit to a SLA with certain key performance indicators (KPIs), chaos testing can allow measuring of whether those KPIs are being met and assess resiliency of the system across all layers to meeting them.

A cellular network slice functions as a virtual network operating on an underlying physical cellular network. Operating on cellular network 120 is some number of cellular network slices, such as hundreds or thousands of network slices. Communication bandwidth and computing resources of the underlying physical network can be reserved for individual network slices, thus allowing the individual network slices to reliably meet defined SLA requirements. By controlling the location and amount of computing and communication resources allocated to a network slice, the QoS and QoE for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus optimization between performance and cost is desirable.

Particular parameters that can be set for a cellular network slice can include: uplink bandwidth per UE; downlink bandwidth per UE; aggregate uplink bandwidth for a client; aggregate downlink bandwidth for the client; maximum latency; access to particular services; and maximum permissible jitter.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include multiple defined slice layers. Each layer within a network slice may be used to define parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

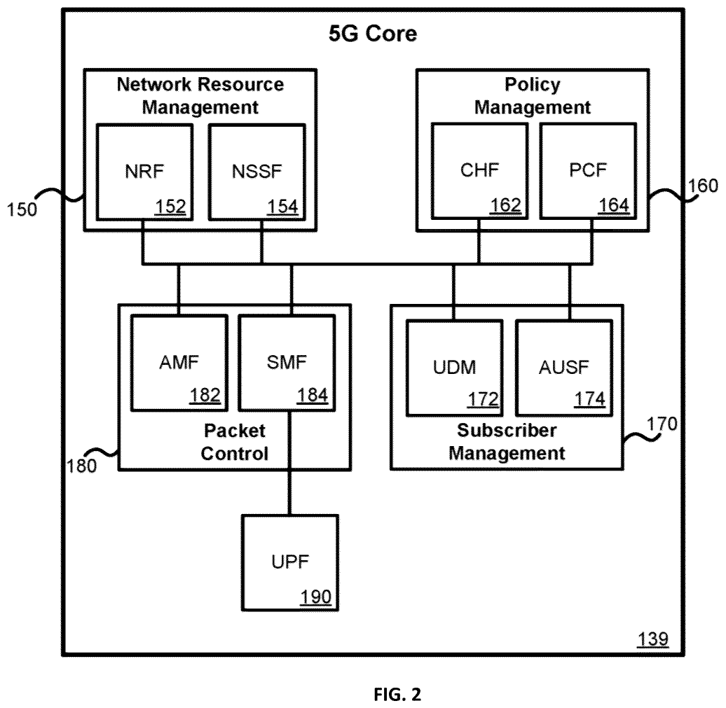

FIG. 2 illustrates a block diagram of a cellular network core, which can represent 5G core 139. 5G core 139 can be implemented on a cloud-computing platform. 5G core 139 can be physically distributed across data centers, or located at a central national data center (NDC), and can perform various core functions of the cellular network. 5G core 139 can include: network resource management components 150; policy management components 160; subscriber management components 170; and packet control components 180. Individual components may communicate on a bus, thus allowing various components of 5G core 139 to communicate with each other directly. 5G core 139 is simplified to show some key components. Implementations can involve additional other components.

Network resource management components 150 can include: Network Repository Function (NRF) 152 and Network Slice Selection Function (NSSF) 154. NRF 152 can allow 5G network functions (NFs) to register and discover each other via a standards-based application programming interface (API). NSSF 154 can be used by AMF 182 to assist with the selection of a network slice that will serve a particular UE.

Policy management components 160 can include: Charging Function (CHF) 162 and Policy Control Function (PCF) 164. CHF 162 allows charging services to be offered to authorized network functions. Converged online and offline charging can be supported. PCF 164 allows for policy control functions and the related 5G signaling interfaces to be supported.

Subscriber management components 170 can include: Unified Data Management (UDM) 172 and Authentication Server Function (AUSF) 174. UDM 172 can allow for generation of authentication vectors, user identification handling, NF registration management, and retrieval of UE individual subscription data for slice selection. AUSF 174 performs authentication with UE.

Packet control components 180 can include: Access and Mobility Management Function (AMF) 182 and Session Management Function (SMF) 184. AMF 182 can receive connection-and session-related information from UE and is responsible for handling connection and mobility management tasks. SMF 184 is responsible for interacting with the decoupled data plane, creating updating and removing Protocol Data Unit (PDU) sessions, and managing session context with the User Plane Function (UPF).

User plane function (UPF) 190 can be responsible for packet routing and forwarding, packet inspection, QoS handling, and external PDU sessions for interconnecting with a Data Network (DN) 195 (e.g., the Internet) or various access networks 197. Access networks 197 can include the RAN of cellular network 120 of FIG. 1A.

The functions illustrated in FIG. 2 as part of 5G core 139 are merely exemplary. Many more or different functions may be implemented in the cellular network core and may vary by slice. The amount of computing resources devoted to a particular function can vary by slice.

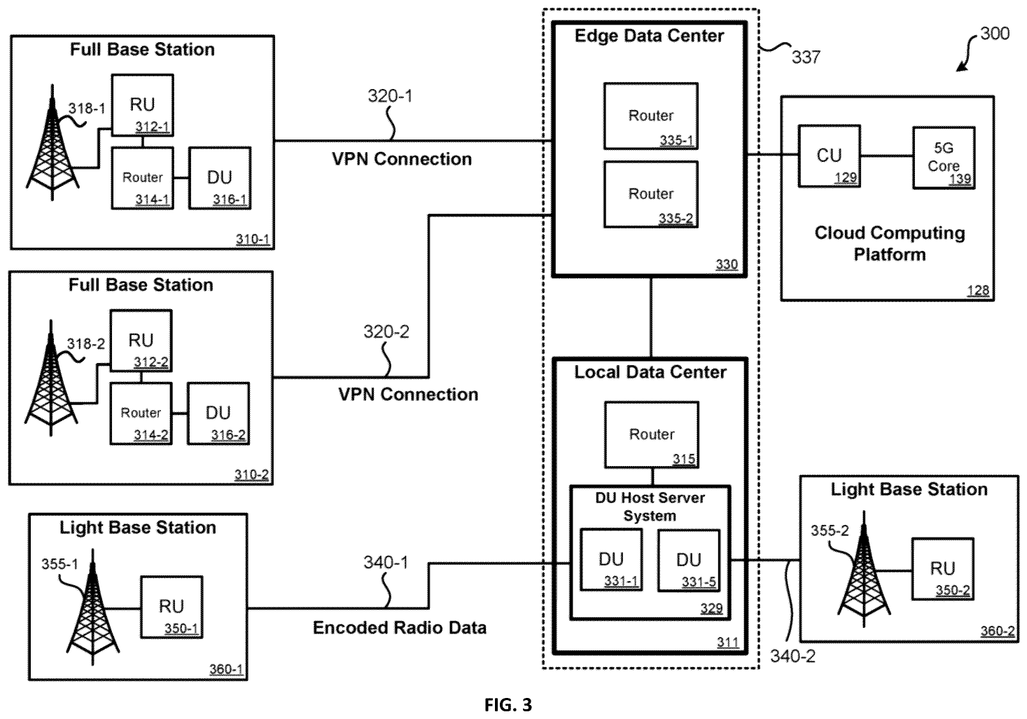

FIG. 3 illustrates an embodiment of hybrid cellular network system 300 (“system 300”) that includes hybrid use of local and remote DUs in communication with a cloud computing platform that hosts the cellular network core. System 300 can include: LDC 311; light BSs 360; full BSs 310; VLAN connections 320; edge data center 330 (“EDC 230”); CU 129; and 5G core 139, which are executed on cloud computing platform 128. In system 300, some base stations, referred to as “full base stations,” have DUs implemented locally at each BS. In contrast, a “light base station” includes structure (e.g., structures 355) and a local radio unit (e.g., RUs 350), but a DU implemented remotely at a geographically separated LDC. In system 300, either light BSs 360 or full BSs 310 may be referred to as a cell site.

LDC 311 can serve to host DU host server system 329, which can host multiple DUs 331 which are remote from corresponding light base stations 360. For example, DU 331-1 can perform the DU functionality for light base station 360-1. DUs with DU host server system 329 can communicate with each other as needed.

LDC 311 can be connected with EDC 330. In some embodiments, LDC 370 and EDC 330 may be co-located in a same data center or are relatively near each other, such as within 250 meters. EDC 330 can include multiple routers, such as routers 335, and can serve as a hub for multiple full BSs 310 and one or more LDCs 311. EDC 330 may be so named because it primarily handles the routing of data and does not host any RAN or cellular core functions. In a cloud-computing cellular network implementation at least some components, such as CU 129 and functions of 5G core 139, may be hosted on cloud computing platform 128. EDC 330 may serve as the past point over which the cellular network operator maintains physical control; higher-level functions of CU 129 and 5G core 139 can be executed in the cloud. In other embodiments, CU 129 and 5G core 139 may be hosted using hardware maintained by the cellular network provider, which may be in the same or a different data center from EDC 330.

Full BSs 310, which include on-site DUs 316, may connect with the cellular network through EDC 330. A full BS, such as full BS 310-1, can include: RU 312-1; router 314-1; DU 316-1; and structure 318-1. Router 314-1 may have a connection to a high bandwidth communication link with EDC 330. Router 314-1 may route data between DU 316-1 and EDC 330 and between DU 316-1 and RU 312-1. In some embodiments, RU 312-1 and one or more antennas are mounted to structure 318-1, while router 314-1 and DU 316-1 are housed at a base of structure 318-1. Full BS 310-2 functions similarly to full BS 310-1. While two full BSs 310 and two light BSs 360 are illustrated in FIG. 3, it should be understood that these numbers of BSs are merely for exemplary purposes; in other embodiments, the number of each type of BS may be greater or fewer.

While encoded radio data is transmitted via the fiber optic connections 340 between light BSs 360 and LDC 370, connection 320-1 between full BSs 310 and EDC 330 may occur over a fiber network. For example, while the connection between light BS 360-1 and LDC 370 can be understood as a dedicated point-to-point communication link on which addressing is not necessary, full BS 310-1 may operate on a fiber network on which addressing is required. Multiprotocol label switching (MPLS) segment routing (SR) may be used to perform routing over a network (e.g., fiber optic network) between full BS 310-1 and EDC 330. Such segment routing can allow for network nodes to steer packetized data based on a list of instructions carried in the packet header. This arrangement allows for the source from where the packet originated to define a route through one or more nodes that will be taken to cause the packet to arrive at its destination. Use of SR can help ensure network performance guarantees and can allow for network resources to be efficiently used. Other full BSs may use the same types of communication link as full BS 310-1. While MPLS SR can be used for the network connection between full BSs 310 and EDC 330, it should be understood that other protocols and non-fiber-based networks can be used for connections 320.

For communications across connection 320-1, a virtual local area network (VLAN) may be established between DU 316-1 and EDC 330, when a fiber network that may also be used by other entities is used. The encryption of this VLAN helps ensure the security of the data transmitted over the fiber network.

Since light BSs 360 are relatively close to LDC 370, typically in a dense urban environment, use of a dedicated point-to-point fiber connection can be relatively straight-forward to install or obtain (e.g., from a network provider that has available dark fiber or fiber on which bandwidth can be reserved). However, in a less dense environment, where full BSs 310 can be used, a point-to-point fiber connection may be cost-prohibitive or otherwise unavailable. As such, the fiber network on which MPLS SR is performed and the VLAN connection is established can be used instead. Further, the total amount of upstream and/or downstream data from a light BS to an LDC may be significantly greater than the amount of upstream and/or downstream data from a DU of a full BS to EDC 337, thus requiring a dedicated fiber optic connection to satisfy the bandwidth requirements of light BSs.

To perform chaos testing, a small portion of the cellular network can be simulated and tested, followed by larger portions of the cellular network as needed to verify functionality and robustness. Once satisfied as to performance in a test environment, testing can be performed in a restricted production environment, followed by release into the general production environment. On each of these levels, some amount of chaos testing can be performed.

### Improvements

According to various embodiments, a UPF runs a health verification towards the Internet to multiple Internet sites, for example, Google or CloudFlare DNS. The health verification may be ping checks. When health verification across multiple sites fail, the UPF proactively takes the pod handling that specific bearer down which then automatically notifies the SMF to stop allocating that pod/IP Pool associated with the pod for Internet Traffic.

In some embodiments, the UPF notifies the SMF that the bearer is down and the SMF should not be initiating any new bearers towards that specific pod until a correction or restoration along the bearer is completed. The SMF and/or the UPF may alert a Network Operations Center (NOC) or operator of the changed status of the pod.

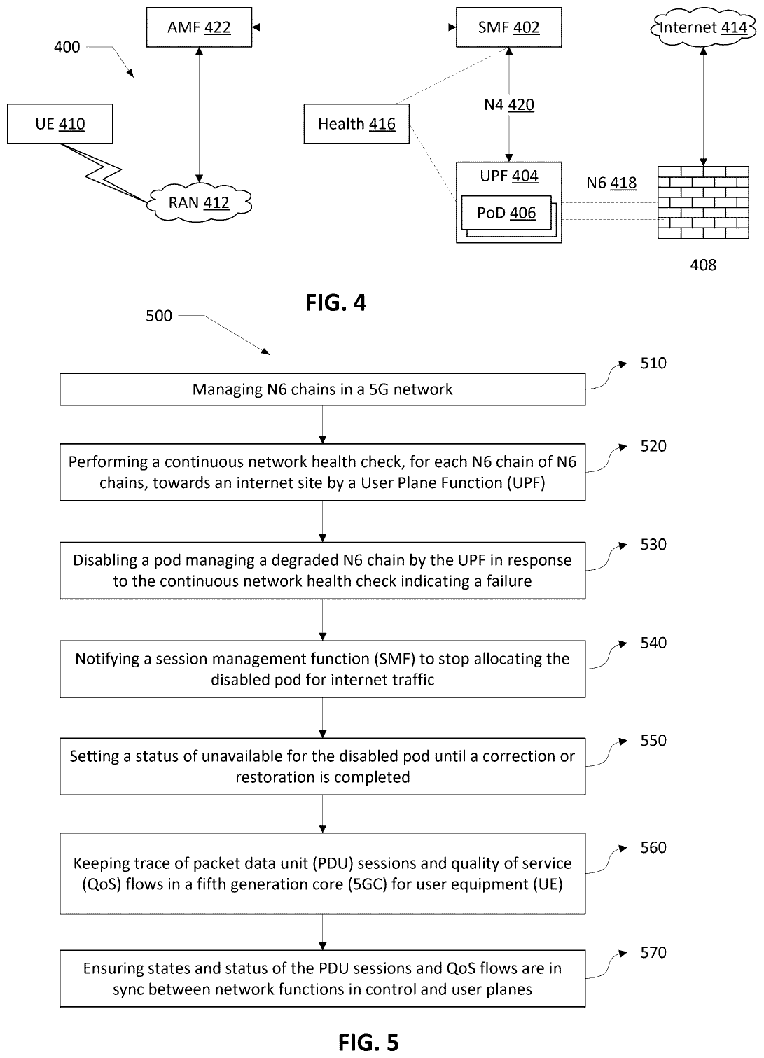

FIG. 4 illustrates a system to manage network connectivity in a Fifth Generation (5G) network, according to various embodiments.

A Network Management System 400 maintains connectivity within a 5G network, ensuring communication and service delivery using an SMF 402, a UPF 404, a pod 406 (pod or Pod is a Point of Delivery) and an IP pool 408 for a UE 410 connected to a RAN 412. SMF 402 conducts health checks and controls allocation of pod 406 resources at the UPF 404 in order to provide internet bearers or a N6 chain 418 able to provide internet 414 connectivity to the UE 410. SMF 402 halts traffic allocation to a degraded pod 406. The UPF 404 manages N6 chains 418, verifies internet connectivity, deactivates the degraded pod 406 associated with a degraded N6 chain 418 upon instruction from SMF 402, and oversees data flow between the UE 410 and internet 414. An authentication and authorization check may be provided an AMF 422 prior to RAN 412 providing connectivity services to UE 410. In some embodiments, SMF 402 may communicated with UPF 404 via an N4 chain 420.

Within the Network Management System 400, UPF 404 monitors network health by performing regular checks towards Internet sites using a health module 416. The health module 416 may be hosted by the UPF 404 or by an external host. This monitoring is designed to detect any degradation in individual N6 chains, a link between user equipment and the data network. Upon detecting a failure, the UPF 404 notifies the SMF 402. SMF 402 disables the affected pod to prevent allocation of compromised resources. The disabled state persists until corrective measures or restoration are completed.

Upon receiving a notification about the disabled pod, SMF 402 stops allocating it for Internet traffic. This action reroutes new sessions to operational pods. The ensures traffic is diverted away from the disabled pod. This coordinated response between SMF 402 and UPF 404 minimizes service disruption and maintains the integrity of the 5G network's service delivery.

UPF 404 maintains network connectivity by performing a network health check towards internet sites (for example, by hosting health module 416 or allowing an external host hosting health module 416 access to N6 chains 418), including domain name servers. This check is periodic and uses methods such as pinging to determine the status of each N6 chain.

FIG. 5 is a flowchart of a method for managing network connectivity in a Fifth Generation (5G) network, according to various embodiments.

A method 500 for managing network connectivity in a 5G network may include multiple operations. At operation 510, the method 500 may include managing N6 chains in a 5G network. Operation 510 includes authenticating, establishing and recording of network connections, for example, N6 connections. Operation 510 may include the detection and correction of network disruptions.

At operation 520, the method 500 includes performing a network health check, for each N6 chain of N6 chains, towards an Internet site by a user plane function (UPF). Operation 520 may be repeated on a periodic or aperiodic basis. The UPF manages multiple N6 service chains, each supported by a pod. User Plane Function (UPF) carries out periodic or aperiodic network health checks toward Internet sites. This is a proactive measure by the UPF to monitor the N6 service chains, which facilitate data transmission between User Equipment (UE) and the Internet. In some embodiments, the health check typically includes sending ICMP echo requests, known as “pings” to assess the response time and availability of a target Internet site. This health check may be performed periodically to verify network connectivity. The Internet sites may be well-known sites, for example, large domain name servers such as Google, CloudFlare and the like. This means that the UPF checks the network's health by querying several DNS servers to ensure redundancy in the health check process. The choice of multiple domain name servers as targets for the health check is strategic, as DNS servers are essential for resolving domain names to IP addresses, a fundamental function for accessing Internet resources. If the response is not received within a predefined timeout period or if the responses indicate an issue, it is considered a sign of a potential problem with the N6 chain managed by a pod.

The UPF performs the health check by specifying the N6 chain as the bearer for the health check. The UPF is a network function within the 5G core network responsible for routing and forwarding user data packets. By performing these health checks, the UPF can detect any degradation in the performance of the N6 chain, which could affect the service experienced by UE. The action of pinging and monitoring the responses is automated, ensuring that any degradation is quickly identified and addressed.

At operation 530, the method 500 includes disabling a pod managing a degraded N6 chain by the UPF in response to the network health check indicating a failure. The UPF is a component within the 5G network's data plane tasked with routing and forwarding user data packets. The UPF oversees multiple pods, with each pod handling different N6 service chains that connect the 5G network to external networks such as the internet. If a health check indicates a failure, the UPF may disable the pod that is managing the degraded N6 chain. The disabling may be immediate or pursuant to instruction from the SMF. This prevents further service degradation and to maintains network integrity.

At operation 540, the method 500 includes notifying a Session Management Function (SMF) to stop allocating the disabled pod for Internet Traffic. Following the failure, the UPF notifies the Session Management Function (SMF). The SMF, which operates within a Regional Data Center (RDC), manages Packet Data Unit (PDU) sessions and Quality of Service (QoS) flows. The communication from the UPF to the SMF serves to inform the latter that the pod in question should no longer be used for routing Internet Traffic. The communication (operation 540) is a standard procedure within the 5G network infrastructure, where the UPF sends a signal or message to the SMF using established signaling protocols. The SMF, upon receiving this notification, updates its resource management to exclude the disabled pod from future session allocations.

In some embodiments, the UPF and/or the SMF may also engage in a notification process that includes alerting a Network Operations Center (NOC). The NOC is tasked with overseeing the network's performance and addressing any issues that arise. The information provided by the UPF enables the NOC to coordinate responses to the detected network degradation, such as initiating repair or restoration efforts. The UPF and SMF are software functions that handle different aspects of network operation. The UPF focuses on data plane activities, including the routing of user data packets, while the SMF is responsible for session management tasks. When a pod is identified as non-operational by the UPF, the SMF is prompted to redirect traffic to other functional pods, thereby maintaining service continuity for users.

At operation 550, method 500 includes setting a status of unavailable for the disabled pod until a correction or restoration is completed. Upon notification, in some embodiments, the SMF ceases to allocate the disabled pod for Internet traffic and marks its status as unavailable. This status may be maintained until the necessary corrections or restorations are made. The SMF may also allocate new N6 chains on a different pod to replace the N6 chains associated with the disabled. This reallocation is a measure taken to ensure that user equipment connected to the 5G network retains access to external networks without service interruption. The SMF's capability to manage and redirect traffic is essential for maintaining network resilience and service reliability.

At operation 560, method 500 includes keeping trace of Packet Data Unit (PDU) sessions and Quality of Service (QoS) flows in a Fifth Generation Core (5GC) for User Equipment (UE). The SMF ensures that the states and status of PDU sessions and QoS flows remain consistent across Network Functions in the Control and User Planes. This consistency is essential for the network's operation and the service provided to users. Operation 560 involves monitoring and recording the status of all active PDU sessions. A PDU session represents the data connectivity between the UE and the data network. The SMF tracks these sessions to manage the data paths and to ensure that the UE maintains a connection. The QoS flows are settings that govern the treatment of packets within the PDU sessions, ensuring that data is managed according to the needs of different services.

In essence, method 500 encompasses the procedures for maintaining network connectivity by conducting health checks, disabling degraded service chains, and coordinating with the SMF to manage the allocation of network resources, thereby maintaining service quality and network availability.

At operation 570, method 500 includes ensuring states and status of the PDU sessions and QoS flows are in sync between Network Functions in Control and User Planes. The SMF coordinates with other network functions to maintain a synchronized state of the network. This synchronization is necessary for the network to provide service to the UE, as it moves or as network conditions change. The Control Plane makes decisions about where and how data should be sent, while the User Plane is where data transfer occurs. Keeping these planes in sync means that the decisions made by the Control Plane are accurately reflected in the data handling of the User Plane.

The SMF performs these actions to ensure that the network can adapt to changes, such as the degradation of an N6 chain, without interrupting the user's data service. By maintaining records of PDU sessions and QoS flows, the SMF can facilitate rerouting or reallocation of N6 chains of data traffic in the event of a network issue. This proactive management is essential for maintaining service availability and quality in the dynamic environment of a 5G network.

Having described preferred embodiments of a system and method (which are intended to be illustrative and not limiting), it is noted that modifications and variations can be made by persons skilled in the art considering the above teachings. It is therefore to be understood that changes may be made in the embodiments disclosed which are within the scope of the invention as outlined by the appended claims. Having thus described aspects of the invention, with the details and particularity required by the patent laws, what is claimed and desired protected by Letters Patent is set forth in the appended claims.

We claim as our invention:

1. A method for managing network connectivity in a Radio Access Network (RAN), the method comprising:
performing a network health check, for each N6 chain of N6 chains, towards an Internet site by a user plane function (UPF);
disabling a pod managing a degraded N6 chain by the UPF in response to the network health check indicating a failure;
notifying a Session Management Function (SMF) to stop allocating the disabled pod for Internet Traffic; and
setting a status of unavailable for the disabled pod until a correction or restoration is completed.

2. The method of claim 1, wherein the Internet site comprises multiple domain name servers.

3. The method of claim 1, wherein the UPF has multiple pods that handle multiple N6 service chains.

4. The method of claim 1, wherein the SMF is deployed in a Regional Data Center (RDC) and communicates with multiple UPFs for data service.

5. The method of claim 1, wherein the SMF selects a UPF for a UE after an Access Gateway Function (AGF) authenticates the UE and establishes a protocol data unit (PDU) session.

6. The method of claim 1, further comprising keeping trace of Packet Data Unit (PDU) sessions and Quality of Service (QoS) flows in a Fifth Generation Core (5GC) for User Equipment (UE).

7. The method of claim 6, further comprising ensuring states and status of the PDU sessions and QoS flows are in sync between Network Functions in Control and User Planes.

8. The method of claim 1, further comprising setting a status of unavailable for the disabled pod until a correction or restoration is completed.

9. The method of claim 1, wherein the disabled pod is associated with an IP Pool for Internet Traffic and the SMF replaces N6 chains associated with the disabled pod by allocating new N6 chains on a different pod.

10. The method of claim 1, wherein the network health check comprises pinging an Internet host periodically.

11. The method of claim 1, wherein the notifying comprises alerting a Network Operations Center (NOC).

12. A system to manage network connectivity in a Radio Access Network (RAN), the system comprising:
a user plane function (UPF) configured to perform a network health check, for each N6 chain of N6 chains, towards an Internet site, to disable a pod associated with a degraded N6 chain in response to the network health check indicating a failure, and to send a notification regarding the disabled pod; and
a Session Management Function (SMF) configured to stop allocating the disabled pod for Internet Traffic in response to the notification from the UPF.

13. The system of claim 12, wherein the Internet site comprising multiple domain name servers.

14. The system of claim 12, wherein the UPF has multiple pods that handle multiple N6 service chains.

15. The system of claim 12, wherein the SMF is deployed in a Regional Data Center (RDC) and communicates with multiple UPFs for data service.

16. The system of claim 12, wherein the SMF selects a UPF for a User Equipment (UE) after an Access Gateway Function (AGF) authenticates the UE and establishes a protocol data unit (PDU) session.

17. The system of claim 12, wherein the SMF keeps trace of Packet Data Unit (PDU) sessions and Quality of Service (QoS) flows in a Fifth Generation Core (5GC) for User Equipment (UE).

18. The system of claim 17, wherein the SMF ensures states and status of the PDU sessions and QoS flows are in sync between Network Functions in Control and User Planes.

19. The system of claim 12, further comprising the SMF sets a status of unavailable for the disabled pod until a correction or restoration is completed.

20. The system of claim 12, wherein the pod is associated with an IP Pool for Internet Traffic and the SMF replaces N6 chains associated with the disabled pod by allocating new N6 chains on a different pod.
